(19) United States
(12) Patent Application Publication
(10) Pub. No.: US 2021/0010173 A1
(43) Pub. Date: Jan. 14, 2021

(54) METHOD FOR PREPARING HALOGEN-FREE LOW-SMOKE INTRINSIC FLAME-RETARDANT NYLON 66 COMPOSITE MATERIAL

(71) Applicant: Northwest Normal University, Lanzhou (CN)

(72) Inventors: Ziqiang Lei, Lanzhou (CN); Hui Fan, Lanzhou (CN); Xinyao Lv, Lanzhou (CN); Yaoxia Yang, Lanzhou (CN); Wei Zeng, Lanzhou (CN); Zhiwang Yang, Lanzhou (CN)

(21) Appl. No.: 16/743,498

(22) Filed: Jan. 15, 2020

(30) Foreign Application Priority Data
Jul. 10, 2019 (CN) 201910617245.1

(51) Int. Cl. D03D 15/12; D02G 3/44

(52) U.S. Cl. CPC D03D 15/12; D10B 2331/02; D02G 3/443

(57) ABSTRACT

The present invention discloses a method for preparing a halogen-free low-smoke intrinsic flame-retardant nylon 66 composite material, which is implemented according to a conventional preparation process by taking an organic acid-modified metal hydroxide as a flame retardant. According to the present invention, an organic acid containing flame-retardant elements such as P, N and S is used for carrying out reactive modification on the metal hydroxide, so that the agglomeration behavior of the metal hydroxide in a polymer is effectively reduced, the compatibility between the flame retardant and nylon 66 is improved. Meanwhile, a series of flame-retardant functional groups such as P, N and S are introduced, so that the flame retardancy of the nylon 66 is greatly improved, the smoke suppression effect is achieved to a certain extent. Therefore, the prepared intrinsic nylon 66 composite material has desirable flame retardancy (an oxygen index can reach 25.8) and low smoke effect.

### TECHNICAL FIELD

The present invention relates to a flame-retardant nylon 66 composite material, and in particular to method for preparing a halogen-free low-smoke intrinsic flame-retardant nylon 66 composite material, belonging to the technical field of flame-retardant materials and high polymer materials.

### BACKGROUND

Nylon's output ranks first in engineering plastics and nylon has become an indispensable structural material in all walks of life. Nylon 66 has an output as high as 50% of total nylon output due to its excellent mechanical properties, desirable friction and excellent heat resistance and electrical insulation properties. Nylon 66 has certain flame retardancy. According to the U.S. UL94 standard, the flame-retardant grade of nylon 66 can reach V-2 upon vertical burning test, and the value can reach 24 through oxygen index measurement. Therefore, nylon materials can be used in occasions with low flame-retardant requirements.

Although nylon materials have certain flame-retardant properties, flame retardancy of nylon itself cannot meet existing use requirements in industries such as home appliances and electronic appliances that require high flame-retardant properties of materials. The improvement of the flame retardancy of nylon 66 is mainly realized through two ways: (1) The flame retardant and the nylon 66 are processed and produced through physical blending with a twin screw extruder by adopting a mechanical blending method, so that the material has flame retardancy, that is, flame retardant additives are added in the compounding process. The method is convenient to use and widely applied, but the additive flame retardant is large in dosage and low in efficiency, and mechanical properties of the composite material are reduced due to poor compatibility between the flame retardant and a nylon 66 matrix. (2) A reactive flame retardant is added to a resin matrix, that is, the flame retardant participates in the reaction as a reactive monomer and is bonded to a main chain or a side chain of the nylon 66. These functional groups have strong flame-retardant activity. The advantages are desirable flame-retardant stability, optimal flame retardancy, little influence on mechanical properties of the material, and low toxicity.

As people pay more and more attention to environmental protection requirements, blending and reactive brominated flame retardants widely used in the past have been eliminated due to their environmental risks. At present, the release of toxic phosphine can be effectively avoided by adopting methods of production of microencapsulated red phosphorus and red phosphorus master batch in phosphorus-based flame-retardant nylon. However, due to its comparative tracking index (CTI) reaching 600 V and its flame retardancy not as good as the phosphorus-based flame-retardant nylon, application occasions of the microencapsulated red phosphorus and red phosphorus master batch are also limited. Metal hydroxides such as aluminum hydroxide and magnesium hydroxide in inorganic flame retardants can isolate air due to their large heat absorption capacity in decomposition and the generation of H₂O. The oxides after decomposition are also high temperature-resistant substances. Therefore, the two flame retardants can not only play a flame-retardant role, but also play a filling role. The two flame retardants have the characteristics of no generation of corrosive halogen gas and harmful gas, no volatilization, lasting effect, no toxicity, no smoke, no melting and dripping, and the like. However, the two flame retardants have poor compatibility with a polymer, and agglomerate easily. Besides, the addition amount is large, and thus the flame retardants need to be subjected to surface modification, so that there is no negative impact on mechanical properties while the flame retardancy of the nylon 66 is increased.

### SUMMARY

In view of the foregoing defects in the prior art, an objective of the present invention is to provide a method for preparing a halogen-free low-smoke intrinsic flame-retardant nylon 66 composite material.

I. Preparation of a Halogen-Free Low-Smoke Intrinsic Flame-Retardant Nylon 66 Composite Material

(1) Preparation of an Organic Modified Flame Retardant

A metal hydroxide is ultrasonically dispersed in distilled water, an organic acid is added, and heating and stirring are performed at 60-100° C. for reaction for 5-8 h; and after the solvent is removed by rotary evaporation, the mixture is dried for 20-24 h at 60-100° C. to obtain an organic-modified inorganic flame retardant.

The metal hydroxide is aluminum hydroxide, magnesium hydroxide and calcium hydroxide. The organic acid is 2-carboxyethyl(phenyl)phosphinic acid, phenylphosphonic acid, ethylenediamine tetra(methylene phosphonic acid) or sulfanilic acid; and the mass ratio of the metal hydroxide to the organic acid is (1:2)-(1:8).

(2) Preparation of an Intrinsic Nylon 66 Composite Material

Nylon 66 salt and distilled water are prepared into a water solution with a mass percent of 60%, and adipic acid is added to adjust the pH of the solution to about 7.6; the organic modified flame retardant prepared in step (1) is solved in distilled water, and the pH is adjusted to about 7.6 with 1,6-hexanediamine; the two prepared solutions are poured into a high-temperature and high-pressure reaction kettle and stirred for uniform mixing, and nitrogen is continuously and repeatedly introduced to empty air in the system; heating is performed to make the system pressure be 1.75-1.85 MPa, polycondensation is performed for 1-1.5 h, air is discharged for pressure relief to make the system pressure be 0, vacuumizing is performed for 5-30 min to make the system temperature reach 270-280° C., the final polycondensation of the nylon 66 is completed, 0.3-0.5 MPa of nitrogen is introduced, and the material stands for 8-30 min and then is discharged to obtain a halogen-free low-smoke flame-retardant nylon 66 composite material.

II. Characterization of the Halogen-Free Low-Smoke Intrinsic Flame-Retardant Nylon 66 Composite Material

Inorganic particle magnesium hydroxide is taken as an example below. The structure obtained the magnesium hydroxide is subjected to organic functionalization with 2-carboxyethyl(phenyl) phosphinic acid and the preparation and properties of the halogen-free low-smoke flame-retardant nylon 66 composite material are described below.

FIG. 1 is an infrared absorption spectrum curve of organic functionalization of inorganic particle magnesium hydroxide. As can be seen from FIG. 1, a stretching vibration peak of —OH of magnesium hydroxide (MH) is at the position of 3695 cm⁻¹, stretching vibration peaks of C═O bond, P—OH bond and P═O of 2-carboxyethyl(phenyl)phosphinic acid (CEPPA) are at the positions of 1734 cm⁻¹, 972 cm⁻¹ and 1147 cm⁻¹, respectively, and a vibration absorption peak of P-Ar is at the position of 1419 cm⁻¹. However, the disappearance of an absorption peak at the position of 972 cm⁻¹ in CEPPM indicates that the P—OH bond has been reacted by MH, and it can be determined that the flame retardant has been successfully prepared.

FIG. 2 is an SEM graph of magnesium hydroxide, 2-carboxyethyl(phenyl)phosphinic acid and a synthesized flame retardant. It can be seen that magnesium hydroxide (a) has a sheet structure under SEM, 2-carboxyethyl(phenyl)phosphinic acid (b) has a pellet shape, and the morphology after the reaction of the two presents a rod-like structure (c), which further confirms the successful synthesis of the flame retardant.

FIG. 3 is an infrared absorption spectrum curve of halogen-free low-smoke flame-retardant nylon 66. As can be seen from FIG. 3, a stretching vibration peak of N-H bond, a stretching vibration peak of C—O bond and a bending vibration peak of N-H bond, which are characteristic absorption peaks of the nylon 66, still exist at the positions of 3306 cm⁻¹, 1635 cm⁻¹ and 1539 cm⁻¹ of the synthesized flame-retardant nylon 66. In addition, a new absorption peak at the position of 1423 cm⁻¹ is an absorption peak of P-Ar, and an absorption peak at the position of 1142 cm⁻¹ should be an absorption peak of P═O bond, which indicates that the flame retardant has been successfully polymerized in nylon 66.

FIG. 4 is a graph showing the total heat release of PA66 (nylon 66) when different proportions of flame retardant are added. As can be seen from FIG. 4, as the proportion of the flame retardant in nylon 66 increases gradually, the total heat release rate of FRPA66 decreases gradually, indicating that the addition of the flame retardant effectively improves the flame retardancy of nylon 66.

FIG. 5 is a graph showing the heat release rate of nylon 66 when different proportions of flame retardant are added. The results of FIG. 5 show that the peak heat release rate of pure nylon 66 reaches 965.9 kW/m², and the heat release rate reaches 100.0 kW/m². When 5% flame retardant is added, the peak heat release rate of nylon 66 drops to 820.2 kW/m², with a decrease by 15.1%; and the heat release rate drops to 97.9 kW/m², with a decrease by 2.1% compared with the pure sample, while after 9% flame retardant is added, the peak heat release rate drops by 18.7%, indicating that the synthesized flame retardant has a desirable flame-retardant effect.

Table 1 shows specific data of limit oxygen index (LOI), heat release rate (HRR), peak heat release rate (PHRR), total smoke production (TSP) and carbon dioxide production (CO₂P) of nylon 66 when different proportions of flame retardant are added. It can be seen that the nylon 66 with different proportions of flame retardant added still has desirable flame retardancy without compounding other flame retardants.

TABLE 1

| Sample | THR (MJ/m²) | PHRR (kW/m²) | TSP (m²) | LOI (%) |
|---|---|---|---|---|
| PA66 | 100.0 | 965.9 | 9.1 | 24.0 |
| FRPA66 5% | 97.9 | 820.2 | 6.2 | 24.7 |
| FRPA66 9% | 93.8 | 784.6 | 6.1 | 25.8 |

III. Performance Test of the Halogen-Free Low-Smoke Intrinsic Flame-Retardant Nylon 66 Composite Material

Test method: GB/T2460-93 standard test is adopted. Test results show that the oxygen index can reach 25.8, which indicates that nylon 66 is modified by the intrinsic flame retardant method of the present invention, so that nylon 66 has desirable flame retardancy.

In conclusion, according to the present invention, an organic acid containing flame-retardant elements such as P, N and S is used for carrying out reactive modification on the metal hydroxide (inorganic flame retardant), so that the agglomeration behavior of the metal hydroxide in a polymer is reduced, and the compatibility between the flame retardant and nylon 66 is improved. Meanwhile, a series of flame-retardant functional groups such as P, N and S are introduced, so that the flame retardancy of the nylon 66 is effectively improved, and the smoke suppression effect is achieved to a certain extent. Therefore, the prepared intrinsic nylon 66 composite material has good flame retardancy and low smoke effect.

### BRIEF DESCRIPTION OF THE DRAWINGS

FIG. 1 is an infrared absorption spectrum curve of organic functionalization of inorganic particle magnesium hydroxide;

FIG. 2 is an SEM graph of organic functionalization of inorganic particle magnesium hydroxide;

FIG. 3 is an infrared absorption spectrum curve of flame-retardant nylon 66;

FIG. 4 is a graph showing the total heat release of nylon 66 when different proportions of flame retardant are added; and

FIG. 5 is a graph showing the heat release rate of nylon 66 when different proportions of flame retardant are added.

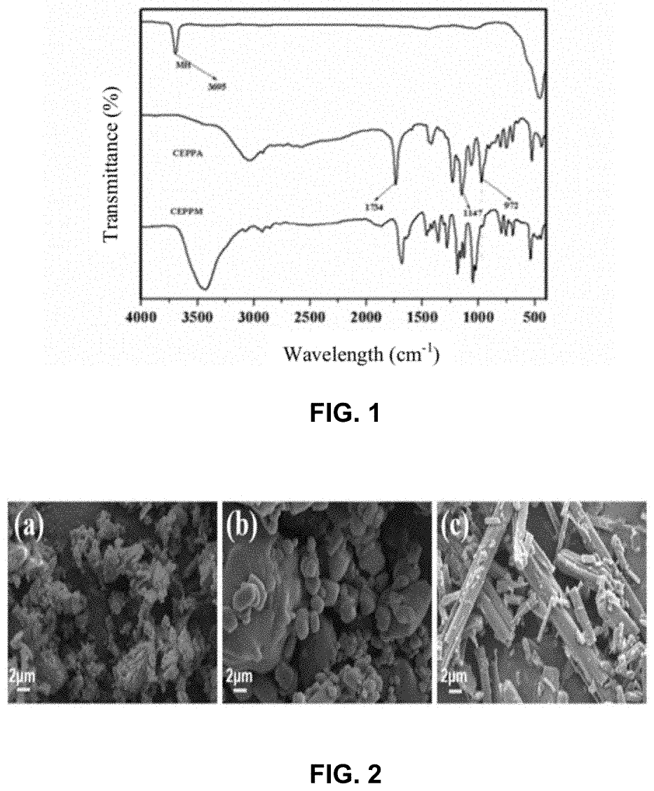

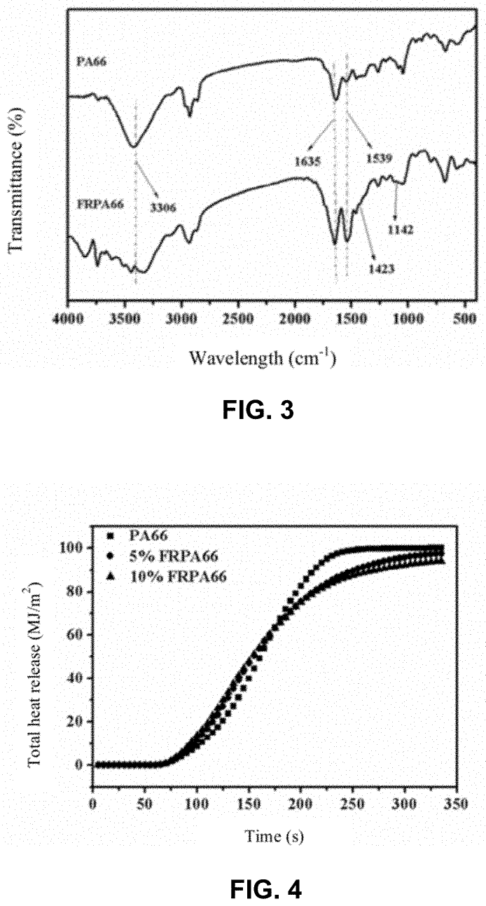

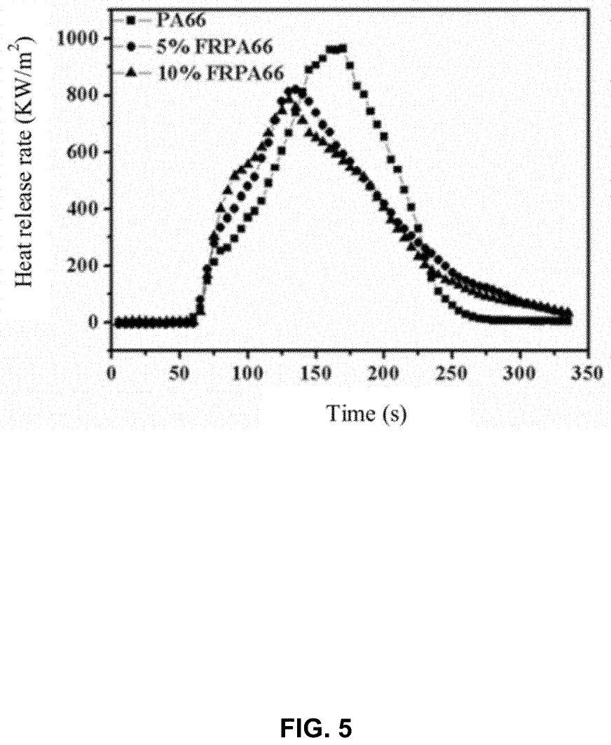

### DETAILED DESCRIPTION

The preparation and flame-retardant properties of a halogen-free low-smoke flame-retardant nylon 66 composite material of the present invention are further explained by specific embodiments.

### Embodiment 1

(1) Preparation of a modified flame retardant: 2.9 g of magnesium hydroxide was dissolved in a round-bottom flask containing 100 mL distilled water, and ultrasonic treatment was performed for 30 min; 10.7 g of 2-carboxyethyl(phenyl)phosphinic acid was added into the flask, magnetic stirring was carried out at 100° C. for 5 h, the solvent was removed by rotary evaporation, and drying was carried out at 80° C. for 24 h to obtain a 2-carboxyethyl(phenyl)phosphinic acid-modified magnesium hydroxide flame retardant.

(2) Synthesis of a halogen-free low-smoke intrinsic flame-retardant nylon 66: 500 g of nylon 66 salt was taken and prepared into a 60% salt solution by using 333 mL of distilled water, and 1.625 g of adipic acid was added to adjust the pH of the solution to about 7.6; 8 g of modified magnesium hydroxide flame retardant synthesized above was taken and dispersed in the distilled water, 4 g of 1,6-hexanediamine was added to adjust the pH to about 7.6; then the two solutions were added in a high-temperature and high-pressure reaction kettle, nitrogen was introduced into the reaction kettle, and air in the system was discharged. After gas replacement was performed three times, the pressure P in the system was kept at 0.3 MPa for 10-20 min. If the gas pressure was not reduced, it was proved that the air tightness of the system was good. Stirring and heating were performed, the stirring speed was 81 r/min, and I was equal to 0.84 A. When the system pressure P rose to 1.75-1.85 MPa, pre-polycondensation was carried out for 1-1.5 h, air was discharged to reduce the system pressure P to 0 within 30-60 min, and vacuumizing was performed to maintain the system under vacuum condition for 5-30 min. The rotating speed was 70-80 r/min, I was equal to 0.77-0.80 A, and stirring was stopped; 0.3-0.5 MPa of nitrogen gas 5was introduced, and the material stood for 8-30 min and then was discharged to obtain a halogen-free low-smoke intrinsic flame-retardant nylon 66 composite material.

(3) Flame-retardant properties of the intrinsic flame-retardant nylon 66 composite material:
LOI=25.8%; THR=93.8 MJ/m², PHRR=784.6 kW/m², and TSP=6.1 m².

### Embodiment 2

(1) Preparation of a modified flame retardant: 3.9 g of aluminum hydroxide was dissolved in a round-bottom flask containing 100 mL distilled water, and ultrasonic treatment was performed for 30 min; 8.66 g of sulfanilic acid was added into the flask, magnetic stirring was carried out at 90° C. for 5 h, the solvent was removed by rotary evaporation, and drying was carried out at 80° C. for 24 h to obtain a sulfanilic acid-modified aluminum hydroxide flame retardant.

(2) Synthesis of a halogen-free low-smoke intrinsic flame-retardant nylon 66: The added flame retardant was the sulfanilic acid-modified aluminum hydroxide flame retardant, and others were the same as those of Embodiment 1.

(3) Flame-retardant properties of the intrinsic flame-retardant nylon 66 composite material:
LOI=24.9%; THR=98.3 MJ/m², PHRR=860.5 kW/m², and TSP=8.3 m².

Embodiment 3

(1) Preparation of a modified flame retardant: organic functionalization of magnesium hydroxide: 2.9 g of magnesium hydroxide was dissolved in a round-bottom flask containing 100 mL distilled water, and ultrasonic treatment was performed for 30 min; 8.66 g of sulfanilic acid was added into the flask, magnetic stirring was carried out at 90° C. for 5 h, the solvent was removed by rotary evaporation, and drying was carried out at 80° C. for 24 h to obtain a sulfanilic acid-modified magnesium hydroxide flame retardant.

(2) Synthesis of a halogen-free low-smoke intrinsic flame-retardant nylon 66: The added flame retardant was the sulfanilic acid-modified magnesium hydroxide flame retardant, and others were the same as those of Embodiment 1.

(3) Flame retardant properties of the intrinsic flame-retardant nylon 66 composite material:
LOI=25.3%; THR=97.9 MJ/m², PHRR=843.5 kW/m², and TSP=8.0 m².

### Embodiment 4

(1) Preparation of a modified flame retardant: 3.9 g of aluminum hydroxide was dissolved in a round-bottom flask containing 100 mL distilled water, and ultrasonic treatment was performed for 30 min; 10.7 g of 2-carboxyethyl(phenyl)phosphinic acid was added into the flask, magnetic stirring was carried out at 100° C. for 5 h, the solvent was removed by rotary evaporation, and drying was carried out at 80° C. for 24 h to obtain a 2-carboxyethyl(phenyl)phosphinic acid-modified aluminum hydroxide flame retardant.

(2) Synthesis of a halogen-free low-smoke intrinsic flame-retardant nylon 66: The added flame retardant was the 2-carboxyethyl(phenyl)phosphinic acid-modified aluminum hydroxide flame retardant, and others were the same as those of Embodiment 1.

(3) Flame-retardant properties of the intrinsic flame-retardant nylon 66 composite material:
LOI=24.7%; THR=98.5 MJ/m², PHRR=860.8 kW/m², and TSP=8.9 m².

### Embodiment 5

(1) Preparation of a modified flame retardant: 2.92 g of magnesium hydroxide was dissolved in a round-bottom flask containing 100 mL distilled water, and ultrasonic treatment was performed for 30 min; 7.95 g of phenylphosphonic acid was added into the flask, magnetic stirring was carried out at 80° C. for 5 h, and the solution was filtered and repeatedly washed with anhydrous ethanol, and dried at 80° C. for 24 h to obtain a phenylphosphonic acid-modified magnesium hydroxide flame retardant.

(2) Synthesis of a halogen-free low-smoke intrinsic flame-retardant nylon 66: The added flame retardant was the phenylphosphonic acid-modified magnesium hydroxide flame retardant, and others were the same as those of Embodiment 1.

(3) Flame-retardant properties of the intrinsic flame-retardant nylon 66 composite material:
LOI=24.7%; THR=98.4 MJ/m², PHRR=858.7 kW/m², and TSP=8.8 m².

### Embodiment 6

(1) Preparation of a modified flame retardant: 0.29 g of magnesium hydroxide was dissolved in a round-bottom flask containing 100 mL distilled water, and ultrasonic treatment was performed for 30 min; 2.18 g of ethylenediamine tetra(methylene phosphonic acid) was added into the flask, magnetic stirring was carried out at 100° C. for 5 h, the solvent was removed by rotary evaporation, and drying was carried out at 80° C. for 24 h to obtain an ethylenediamine tetra(methylene phosphonic acid)-modified magnesium hydroxide flame retardant.

(2) Synthesis of a halogen-free low-smoke intrinsic flame-retardant nylon 66: The added flame retardant was the ethylenediamine tetra(methylene phosphonic acid)-modified magnesium hydroxide flame retardant, and others were the same as those of Embodiment 1.

(3) Flame-retardant properties of the intrinsic flame-retardant nylon 66 composite material:
LOI=25.2%; THR=98.0 MJ/m², PHRR=848.6 kW/m², and TSP=8.2 m².

What is claimed is:

1. A method for preparing a halogen-free low-smoke intrinsic flame-retardant nylon 66 composite material, wherein the composite material is implemented according to a conventional preparation process by taking an organic acid-modified metal hydroxide as a flame retardant.

2. The method for preparing a halogen-free low-smoke intrinsic flame-retardant nylon 66 composite material according to claim 1, wherein a process for preparing the flame retardant by using the organic acid-modified metal hydroxide comprises: ultrasonically dispersing the metal hydroxide in distilled water, adding an organic acid, heating and stirring at 60-100° C. for reaction for 5-8 h; after the solvent is removed by rotary evaporation, drying the mixture for 20-24 h at 60-100° C. to obtain an organic-modified inorganic flame retardant.

3. The method for preparing a halogen-free low-smoke intrinsic flame-retardant nylon 66 composite material according to claim 2, wherein the metal hydroxide is aluminum hydroxide, magnesium hydroxide and calcium hydroxide.

4. The method for preparing a halogen-free low-smoke intrinsic flame-retardant nylon 66 composite material according to claim 2, wherein the organic acid is 2-carboxyethyl(phenyl)phosphinic acid, phenylphosphonic acid, ethylenediamine tetra(methylene phosphonic acid) or sulfanilic acid.

5. The method for preparing a halogen-free low-smoke intrinsic flame-retardant nylon 66 composite material according to claim 2, wherein the mass ratio of the metal hydroxide to the organic acid is (1:2)-(1:8).
